(19) United States
(12) Patent Application Publication
(10) Pub. No.: US 2016/0176565 A1
(43) Pub. Date: Jun. 23, 2016

(54) LABELER AND METHOD FOR APPLYING LABELS PROVIDED WITH AN ACTIVATABLE ADHESIVE

(71) Applicant: KRONES AG, Neutraubling (DE)

(72) Inventors: Volker Kronseder, Neutraubling (DE); Stefan Richter, Thalmassing (DE); Georg Gertlowski, Schierling (DE)

(21) Appl. No.: 14/964,821

(22) Filed: Dec. 10, 2015

(30) Foreign Application Priority Data
Dec. 23, 2014 (DE) 102014226937.7

(51) Int. Cl. B65C 9/26; B29C 49/08; B65C 9/08

(52) U.S. Cl. CPC B65C 9/26; B65C 9/08; B29C 49/08; B29K 2105/258

(57) ABSTRACT

The present disclosure relates generally to a labeler for labeling objects, in particular containers in the food industry. The labeler may have at least one label magazine for providing labels having a fixing side that is activatable by moistening, and at least one palletizing unit including at least one pallet for taking up and transferring individual labels, and at least one activating unit for activating, by moistening, the activatable fixing side of a label that has been taken up by a pallet. The labeler may be configured for directly transferring labels from the pallet of the palletizing unit to an object to be labeled.

### FIELD OF THE INVENTION

The present invention relates to a labeler for labeling objects, a method for labelling objects, and a plant for treating containers.

### BACKGROUND

Nowadays, labelers are on the market, such as the labeler described in EP 0 135 935 B1, in the case of which a large number of labels is first provided through a magazine. These labels are then placed onto individual pallets of a pallet carousel. To this end, the pallets have previously applied thereto a special glue, so that, when the labels are being removed from the magazine, they will adhere to the pallets merely due to the adhesive effect of the glue applied to the pallets. The pallet carousel then turns the respective pallet away from the magazine to a release position at which the label is then mechanically taken over by a gripper cylinder via gripping fingers. In the course of process, the label is quasi turned over, so that the fixing side having glue provided thereon will face radially outwards with respect to the gripper cylinder. The gripper cylinder then rollingly applies the label, with its fixing side first, onto an object to be labeled which moves past said gripper cylinder, and this has the effect that the label will adhere to the object to be labeled due to the adhesive effect of the glue.

Furthermore, as described e.g. in EP 2185425, it is known to activate the adhesive effect of a fixing side of a label by moistening prior to transferring said label to a gripper cylinder, which applies the labels to an object to be labeled.

The known apparatuses and methods for labeling objects are disadvantageous e.g. with respect to the poor environmental sustainability of the glues used, soiling of the labelers through glue, a circumstance that may lead to long cleaning times or even to an increase in labeler downtimes, and the, at present, unsatisfactory labeling precision in cases where the applied labels used have been activated by moistening, and, in addition, the complexity of conventional labelers resulting from the large number of separate components required, said labelers exhibiting thus a comparatively high error proneness and demanding a large amount of maintenance work.

Hence, it is an object of the present disclosure to improve the labeling of objects, e.g. of packs and/or containers in the food industry, in particular with respect to environmental sustainability and the cost effectiveness of labeling.

### SUMMARY

It is believed that this and/or other objects may be achieved by one or more aspects, arrangements, and/or features disclosed in the present application.

According to some aspects, a labeler for labeling objects, such as containers in the food industry, may include at least one label magazine for providing labels having a fixing side that is activatable by moistening, and at least one palletizing unit including at least one pallet for taking up and transferring individual labels, and at least one activating unit for activating, by moistening, the activatable fixing side of a label that has been taken up by a pallet. The labeler is preferably configured for directly transferring labels from the pallet of the palletizing unit to an object to be labeled.

According to some aspects, a method for labeling objects, such as containers in the food industry, may include the steps of providing labels having a fixing side that is activatable by moistening; taking up at least one provided label by means of a pallet of a palletizing unit; activating, through moistening by means of an activating unit, the moisture-activatable fixing side of the label taken up; and directly transferring and applying the label, with the activated fixing side first, to a surface of the object to be labeled by means of the pallet of the palletizing unit.

According to some aspects, a plant for treating containers, may include a filling device for filling the containers, a closing device for closing the filled containers, and a labeler according to any of the various arrangements and aspects of the present disclosure. The labeler may be arranged upstream or downstream of the filling device and/or upstream or downstream of the closing device.

Additional optional aspects, arrangements, developments, and/or features may be realized with reference to the remaining description and the appended claims.

### BRIEF DESCRIPTION OF THE DRAWINGS

FIG. 1 shows an exemplary labeler.

FIG. 2A shows an exemplary side view of a pallet.

FIG. 2B shows an exemplary front view of a pallet.

FIG. 3 shows an exemplary palletizing unit.

FIG. 4 shows an exemplary geometry of the transfer between the pallet and the object to be labeled.

FIG. 5 shows an exemplary plant/exemplary plant block used for treating objects/containers.

### DETAILED DESCRIPTION

A labeler for labeling objects, in particular packs and/or containers in the food industry, may here comprise at least one label magazine for providing labels, preferably single-sheet labels, which may be provided with a fixing side activatable by moistening.

In addition, the labeler may comprise at least one palletizing unit including at least one pallet for taking up and transferring individual labels, and at least one activating unit for activating, e.g. by moistening, the activatable fixing side of a label that has been taken up by a pallet.

The labeler may especially be configured such that it is capable of carrying out a direct transfer of labels from the pallet of the palletizing unit to an object to be labeled.

Direct transfer of labels from a pallet of a palletizing unit to an object to be labeled may here especially mean that labels are transferred without making use of an additional intermediate component, such as a gripper cylinder, between the palletizing unit and the object to be labeled.

It should, however, be mentioned that such direct transfer does not inevitably necessitate that, during transfer of the label to the object to be labeled, the pallet comes into direct contact with the object to be labeled.

The labels used within the framework of the present disclosure are especially intended to be labels exclusively having a fixing side that is activatable only through moisture or fluid. Said activation of the fixing side can activate an adhesive effect of the fixing side.

An activatable fixing side of a label may in particular refer to a label whose one side, i.e. the fixing side, which may e.g. be the back of the label, may be coated with an adhesive agent at least at certain points or in certain areas thereof, the adhesive effect becoming only effective through activation, e.g. through an activation by wetting with an activating agent or a moistening agent.

It follows that the labels have neither glue applied thereto nor is the fixing side of the labels thermally activated. Nor are the labels used within the framework of the present disclosure self-adhesive labels, which would not necessitate the above described activation of the fixing side.

The activatable fixing side of a label may be located on the back of the label or it may be the back of the label.

A labeler according to the present disclosure or a labeling method according to the present disclosure may in some arrangements offer substantial advantages.

For example, in some arrangements a plurality of components of the labeler, such as a glueing station, a gripper cylinder, a glue pump and a glue reservoir, may possibly be dispensed with.

This may be advantageous for the user, not least because soiling by glue no longer occurs and all the costs entailed by obtaining, storing and permanently replenishing the glue are eliminated.

The minimization of the number of components advantageously also may allow a more compact structural design of the labeler, a reduction of the energy requirements as well as an increase in the efficiency of the labeler.

Primarily, however, the glueless labeling according to the present disclosure may allow a better environmental sustainability of the labeling process.

The activating unit may comprise at least one spray head for precisely applying a moistening agent so as to activate the activatable fixing side of the label.

According to an advantageous embodiment, the spray head may be configured as an inkjet print head applying, instead of ink, the activating agent or the moistening agent to the activatable fixing side of the label.

The activating agent or the moistening agent can thus be applied very precisely, this being not least a circumstance that will optimize the amount of activating agent or moistening agent consumed and thus also minimize a possible soiling of the labeler.

Likewise, it is possible that the activation unit includes at least one roller or cylinder, preferably a soft roller, for applying an activating agent to the activatable fixing side of the label. The roller/rollers or cylinder/cylinders may here be adapted to be mechanically driven via a servomotor.

Said rollers or cylinders may be operated such that they are not permanently in an engaged condition, i.e. they are not permanently in contact with pallets of the palletizing unit, but can be switched on selectively, e.g. in a pneumatically controlled manner.

If, for example, no labels are taken up, the cylinder can be moved or switched to a parking position, so that soiling of the pallets can be avoided.

Preferably, a soft roller can be used, whose material comprises e.g. soft sponge, felt or sintered material or the like.

Said roller or cylinder or said soft roller may here be soaked or coated with an activating agent or a moistening agent, which can be applied to said roller or cylinder or said soft roller e.g. by means of a spray head. Also other possibilities of applying an activating agent or a moistening agent to said roller or cylinder or said soft roller are imaginable, such as dipping into an activating agent bath or a moistening agent bath.

However, it is also possible that the activating agent or the moistening agent may be transferred to the activatable fixing side of the label in a less focused manner, in the form of a mist or a vapor.

In addition, the at least one pallet of the palletizing unit of the labeler may be in connection with a vacuum supply unit and/or in connection with a pressurized air supply unit, and the at least one pallet of the palletizing unit may be configured such that, by means of at least one opening, a negative pressure can be generated at and/or pressurized air can be applied to a label contacting side of the pallet.

The negative pressure that can be generated at the label contacting side of the pallet and the negative pressure that can be generated at the/an opening of the label contacting side of the pallet, respectively, can especially be used for taking up and holding the labels. The label contacting side may here be in contact with the front of the label.

By means of the pressurized air supply unit, pressurized air can be discharged at the label contacting side of the pallet and at the/an opening of the label contacting side of the pallet, respectively. Said pressurized air can be used for transferring and/or applying a label that has been taken up by the pallet to an object to be labeled.

Likewise, it is possible that a pallet comprises a plurality of openings at the label contacting side of the pallet and is configured such that said openings can be supplied individually and/or in groups and/or serially and/or simultaneously with pressurized air for pressurized air application, and/or a negative pressure can be generated at said openings individually and/or in groups and/or serially and/or simultaneously.

This advantageously allows very precise handling of the labels, especially while said labels are being taken up from a label magazine and while they are being transferred from the pallet to the object to be labeled. For example, it is possible that a label that has been taken up may be detached from the pallet step by step by applying pressure thereto via said openings and may be applied step by step to the object to be labeled.

If said openings of the label contacting side of the pallet are e.g. arranged in a matrix, openings may be accessed e.g. line by lying or column by column for the purpose of vacuum supply and/or pressure application, so that it will e.g. be possible to detach a label from the pallet line by line or column by column and apply it, line by line or column by column, to the object to be labeled.

Furthermore, the possible use of a vacuum supply for negative pressure generation at the label contacting side of a pallet and/or the possible use of a pressurized air supply unit for pressure application to the label contacting side of a pallet advantageously allows a label to be taken up and/or transferred without the necessity of direct contact of the pallet with a label magazine and/or an object to be labeled.

For example, at a label take-up position for taking up labels from the label magazine and at a predetermined minimum distance between the label contacting side of a pallet and a front of a label provided by the label magazine, the label may be suctionally attracted by a negative pressure generated at the label contacting side of the pallet, and taken up by the pallet, without this necessitating any direct contact between the pallet and the label magazine.

Likewise, at a label transfer position for transferring and applying labels from the pallet to an object to be labeled, a transfer and an application of labels from the pallet to an object to be labeled can, for a predetermined minimum distance, be carried out without any direct contact between the pallet and the object to be labeled.

In this way, e.g. mechanical loads on the labels, caused e.g. when labels get jammed between the pallet and the label magazine and/or between the pallet and the object to be labeled, can be minimized in an advantageous manner.

The labeler may, of course, also be configured such that a contact between the pallet and the label magazine and/or between the pallet and the object to be labeled will be possible.

The control of the application of pressurized air and/or the generation of a negative pressure may e.g. be effected through or supported by uncovering or covering openings of at least one rotary disk, which may be located e.g. at a position between the label contacting side of a pallet and the vacuum supply unit and/or at a position between the label contacting side of a pallet and the pressurized air supply unit.

The application of pressurized air and/or the generation of a negative pressure may especially take place within the framework of selective labeling control, in the case of which e.g. the pressurized air application can be switched off when there is a gap between objects to be labeled, i.e. no transfer of labels will take place at a gap, and/or the removal of labels from a label magazine can be interrupted by switching off the vacuum supply, when there is a gap between objects to be labeled.

This mechanical control of the application of pressurized air and/or of the generation of a negative pressure can advantageously simplify the structural design of the labeler and make the labeler more robust, since e.g. the use of complicated valve technology can be minimized.

In addition, the label contacting side of a pallet my be provided at least partially with an elastic material, e.g. with an elastic sintered plastic material, so that undesired mechanical loads on the labels and/or the objects to be labeled can be minimized in an advantageous manner.

Moreover, the label contacting side of a pallet may be provided with at least one suction cup. Said suction cup may be arranged above or beside an opening of the label contacting side of a pallet.

For the exemplary case that a/the suction cup is arranged above an opening of the label contacting side of a pallet, also said suction cup may have an opening at the connection side between the suction cup and the label contacting side of the pallet, and, consequently, the suction cup may communicate with a vacuum supply unit and/or communicate with a pressurized air supply unit, so that a negative pressure can be generated and/or pressurized air can be applied at the suction cup, in particular at the suction cup side that is adapted to enter into contact with a label.

The label contacting side may also be provided with a plurality of such suction cups, which may be arranged e.g. in a matrix. Suction cups, which are arranged e.g. in lines or in columns, may be accessed individually or in groups, e.g. line by line or column by column, for vacuum supply and/or pressure application, so that a label can e.g. be detached from the pallet line by line or column by column and can be applied, line by line or column by column, to the object to be labeled.

This can advantageously allow a very precise and very careful handling of the labels during the labeling process.

A/the pallet of a palletizing unit may be arranged on the palletizing unit such that it is displaceable along at least three translational axes and at least one or two rotational axes, so that the pallet can be moved to an optimum position with respect to an object to be labeled and so that a large number of differently shaped objects, e.g. conically shaped objects, can optimally be labeled with high precision.

In other words, the pallet can be displaced following e.g. the contour/the shape of the object to be labeled.

In particular, the pallet may be arranged on the palletizing unit such that it is shiftable, e.g. shiftable with respect to an object conveying plane and a container conveying plane, and/or rotatively displaceable, e.g. rotatively displaceable with respect to an object conveying plane and a container conveying plane, and/or tiltable, e.g. tiltable with respect to an object conveying plane and a container conveying plane.

Preferably, the palletizing unit may be configured as a carousel having an axis of rotation, and the pallet may be arranged on the palletizing unit such that it is rotatively displaceable, and the pallet may be arranged such that it is eccentric relative to the axis of rotation of the palletizing unit.

Moreover, the palletizing unit may include a catch basin for collecting excessive activating agent or excessive moistening agent or cleaning agents.

This will advantageously allow e.g. a protection of components of the labeler against the undesired ingress of activating agent or moistening agent. It is also imaginable that the collected activating agent or moistening agent may be reused, possibly by means of e.g. filtering, so that the amount of activating agent or moistening agent consumed can be reduced.

A method according to the present disclosure used for labeling objects, in particular containers in the food industry, may thus comprise e.g. the following steps:
providing labels having a fixing side that is activatable by moistening,
taking up at least one provided label by means of a pallet of a palletizing unit,
activating, through moistening by means of an activating unit, the moisture-activatable fixing side of the label taken up,
directly transferring and applying the label, with the activated fixing side first, to a surface of the object to be labeled by means of a/the pallet of the palletizing unit.

As mentioned above, direct transfer of a label with its activated fixing side by means of a pallet of a palletizing unit to an object to be labeled may here especially mean that no additional component, such as a gripper cylinder, is provided between the palletizing unit and the object to be labeled, or between the palletizing unit and the conveying unit of the object to be labeled.

An exemplary plant according to the present disclosure used for treating containers may comprise a filling device for filling the containers, a closing device for closing the filled containers as well as a labeler of the type described in the present context. Said labeler may be arranged upstream or downstream of said filling device and/or upstream or downstream of said closing device.

If the labeler is arranged e.g. upstream of the filling device, i.e. if the containers are still empty, they may, prior to being labeled, also be inflated or rinsed with sterile air, especially in the case of plastic containers.

In addition, said plant may comprise e.g. a stretch blow molding device disposed upstream of the filling device and used for producing containers from preforms.

Due to the omission of a large number of components, such as gripper cylinders and glueing units, a labeler according to the present disclosure advantageously allows a more compact realization of plants or plant blocks used for treating containers.

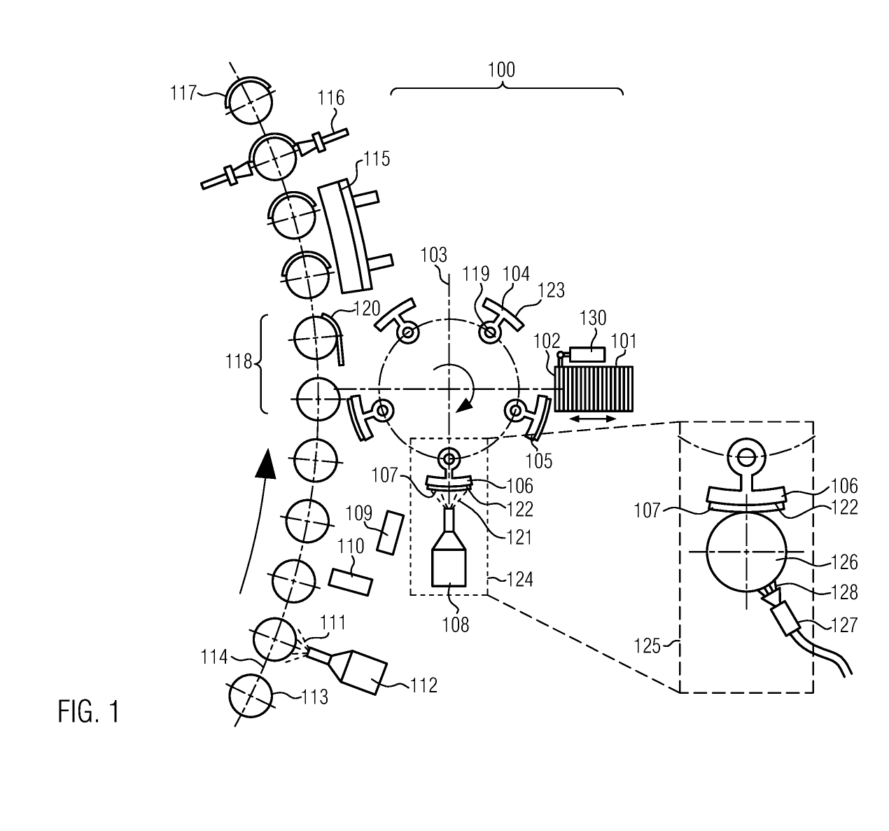

Turning now to the drawings, FIG. 1 exemplarily shows a labeler 100 for labeling objects 114, in particular containers in the food industry.

The labeler 100 may here comprise at least one label magazine 101 for providing labels 102, 107 having a fixing side that is activatable by moistening, and at least one palletizing unit 103 including at least one pallet 104, 105, 106 for taking up and transferring individual labels 102, and at least one activating unit 108 for activating, by moistening, the activatable fixing side 122 of a label 107 that has been taken up by a pallet.

The label magazine 101 may preferably be configured such that it is switchable via a pneumatic cylinder 130.

If, for example, no objects, e.g. containers, to be labeled are present upstream of the inlet to the labeler, the performance of the labeler can be reduced, e.g. to a lower performance, e.g. to a performance equal to or less than approx. 12,000 objects/h, and, if necessary, the labeler can be shut down completely. In addition, a barrier for the objects to be labeled may be activated, and the label magazine may be moved back by a few millimeters in an adequately controlled manner, so that the labeler will operate e.g. in an idling mode.

Exemplarily, the palletizing unit 103 is configured as a carousel comprising at least one pallet, preferably a plurality of pallets (five pallets are shown exemplarily).

The use of a plurality of pallets allows a more effective labeling process.

For example, one pallet 105 may remove a label from the label magazine 101, while e.g. the activatable fixing side 122 of a label 107, which was e.g. taken up previously by another pallet 106, is being activated at an activating unit 108.

As described above, the removal of a label from the label magazine 101 by means of a pallet may be executed by creating a negative pressure at the label contacting side of the pallet.

The labels are placed in the label magazine 101 e.g. such that their front faces the palletizing unit 103 and the label contacting side of a pallet 105, respectively.

While e.g. a removed label is being held by a pallet 105, 106, the activatable fixing side of the label, i.e., for example, the back of the label coated at least partially with an activatable adhesive, may face outwards, so that this activatable fixing side 122 of the label is accessible for further treatment, in particular for an activation of the glueing or adhesive effect of the activatable fixing side of the label.

Through the movements of the pallet/pallets with and on the palletizing unit 103, a label, while positioned on the palletizing unit 103, may describe substantially a circular arc, aside from possible additional movements of the pallet on the palletizing unit, such as rotary movements about an axis of rotation of a pallet, which may e.g. be superimposed on the rotary movement of the palletizing unit 103 about an axis of rotation of the palletizing unit.

As mentioned above, a pallet may additionally be arranged on a palletizing unit such that it is movable and adjustable, in particular shiftable and/or rotatable and/or tiltable and/or vertically adjustable, and, by way of example, it may have an axis of rotation 119 that may be arranged eccentrically on a palletizing unit.

As shown exemplarily, the label contacting side 123 of a pallet 104 may e.g. have a convex curvature.

At an activation position 124, activation of the activatable fixing side 122 of a label 107 may take place.

The application of an activating agent or moistening agent 121 for activating the activatable fixing side 122 of a label 107, e.g. by moistening, can here be executed by spraying an aqueous solution through a spray head, which may be configured e.g. as an inkjet print head.

Preferably, an inkjet print head operating according to the DoD technique (drop-on-demand) would be particularly suitable for this purpose.

For example, it would be imaginable to store a master matrix for each label format/each label shape e.g. in a machine control of the labeler, so as to be able to apply, if necessary and in accordance with the respective type of labeling, the drops of an activating agent/moistening agent to the activatable fixing side of the label, following precisely the shape of the label, and so as to be able to thus activate the respective fixing side in an adequately precise manner.

Said drops of an activating agent/moistening agent may here be applied without contact between the inkjet print head and the activatable fixing side of the label.

In addition, and irrespectively of the mode of application, the activating agent/moistening agent may, if necessary, e.g. be heated before it is applied to the activatable fixing side of the label.

As mentioned above, it is also imaginable to apply the activating agent to the activatable fixing side 122 of a label 107 by means of rollers or cylinders (not shown), preferably by means of soft rollers.

This option is exemplarily shown by the alternative embodiment 125 of the activation position 124, in the case of which a soft roller 126 is used for applying an activating agent or moistening agent 128 to the activatable fixing side 122 of a label 107, so as to activate the activatable fixing side 122 of the label 107.

The soft roller 126 may here be supplied with activating agent or moistening agent 128 via a spray head 127. It is also imaginable to dip the soft roller 126 at least partially into an activating agent bath or moistening agent bath, so as to wet or soak the soft roller 126 with the activating agent or moistening agent 128.

At a labeling position 118, i.e. the position or the area of direct transfer of a label from a pallet of the palletizing unit to an object to be labeled, a label 122 can be applied at least partially to an object to be labeled.

As described above, the label can here be transferred making use of pressurized air that is applied at a label contacting side of a pallet, whereby an object 117 labeled in the desired way will be obtained.

Ambient conditions, such as temperature and/or moisture/humidity, may sometimes have a significant influence on the quality of the labeling process, and, consequently, e.g. ambient condition sensors 109, 110 may be used, e.g. for measuring the temperature and/or moisture in the surroundings of the activating unit and/or in the surroundings of objects 113 to be labeled, which are positioned on a conveying unit 114.

Based on the measurements of e.g. the temperature and/or the moisture/humidity as well as depending on the surface character of an object to be labeled, the amount of activating agent, e.g. the degree of moistening, used for activating the activatable fixing side of a label may be varied, so as to allow optimum adherence of the label.

In other words, a feedback between the ambient condition sensors 109, 110—and possible additional sensors (not shown) measuring the condition of the surface character of the object to be labeled—and the activating unit 108 can be utilized for controlling the application of the activating agent or the moistening agent.

Optionally, a pretreating unit 112 may prepare an object to be labeled 113 for the labeling step insofar as the object area to be labeled of the object 113 may be cleaned e.g. by means of a pretreating agent 111 and/or permoistened e.g. with an activating agent.

A pretreatment by the pretreating unit 112 may also comprise blowing off, a heating and/or radiation treatment and/or a plasma and/or corona treatment and/or some other treatment for energy input, so as to be thus able to improve the adherence of the labels to the objects to be labeled, e.g. packs or containers.

Tempered glass bottles may be pretreated e.g. with a alcohol-water solution having a suitable temperature, whereas the pretreatment of PET bottles may be carried out e.g. by means of irradiation with plasma.

Likewise, a label 120 that was e.g. transferred only partially or not completely from a pallet to an object to be labeled at a labeling position 118 can be fully applied e.g. by a roll-on unit 115 and/or by a brush-on unit 116.

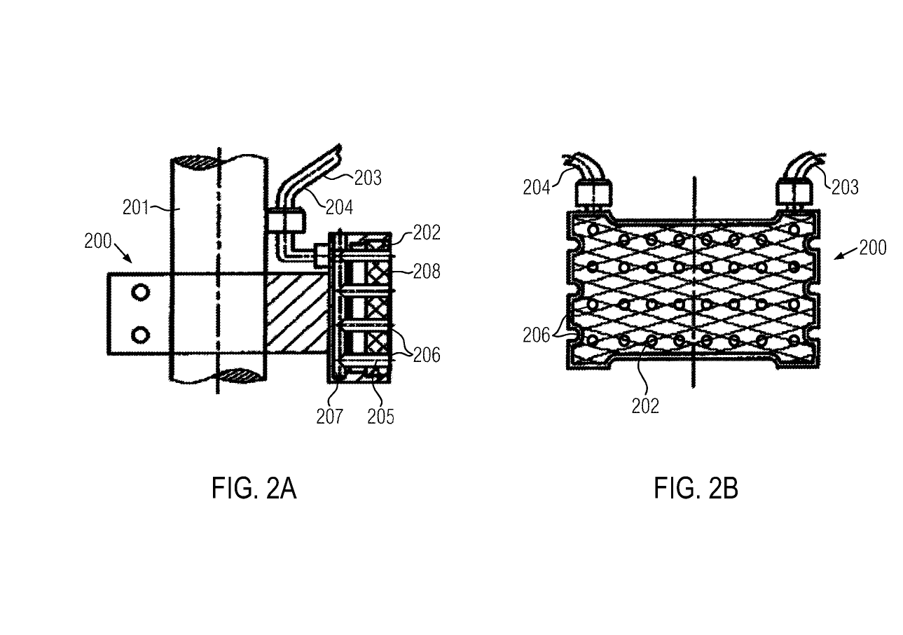

FIG. 2a shows a side view of an exemplary pallet 200 of a palletizing unit, said pallet 200 being supported such that it is rotatable e.g. about an axis of rotation 201. The pallet may have a label contacting side 202 that may be provided, at least partially, with an elastic material 208, e.g. with an elastic sintered plastic material.

The pallet may comprise a channel or channels 205, which may be in connection 203 with a vacuum supply unit (not shown) and/or in connection 204 with a pressurized air supply unit (not shown). Said channel/channels may end in a respective opening/openings 205 at the label contacting side 202 of the pallet 200.

Said connection 203 to a vacuum supply unit and/or said connection 204 to a pressurized air supply unit may additionally be established through a main channel or through a plurality of main channels 207 from which said channel/said channels 205 may branch off.

It follows that said opening/openings 206 allow(s) to selectively generate a negative pressure at the label contacting side 202 of the pallet 200 and/or to apply pressure at the label contacting side 202 of the pallet 200.

FIG. 2b shows a front view of an exemplary pallet of a palletizing unit, e.g. of the pallet 200.

As mentioned above, the label contacting side 202 of the pallet may have a large number of openings 206, which, as described in FIG. 2a, may be in connection 203 with a vacuum supply unit (not shown) and/or in connection 204 with a pressurized air supply unit (not shown) e.g. via a system of channels.

The shape of the openings 206 may here be substantially circular, but other opening shapes, such as slots, are imaginable as well.

Furthermore, pressure for an application of pressure may be supplied to said openings 206 individually and/or in groups and/or serially and/or simultaneously, and/or a negative pressure may be generated at said openings 206 individually and/or in groups and/or serially and/or simultaneously.

As shown, said openings 206 of the label contacting side 202 of the pallet may be arranged e.g. in a matrix, and the openings 206 may be accessed line by line or column by column for vacuum supply and/or for pressure application, so that a label may be detached from the pallet e.g. line by line or column by column and may be applied, line by line or column by column, to the object to be labeled.

Furthermore, as described above, the label contacting side 202 of the pallet 200 may also be provided with at least one suction cup (not shown) or a plurality of suction cups, the respective suction cup/suction cups being arranged e.g. above or beside an opening 206 of the label contacting side of a pallet.

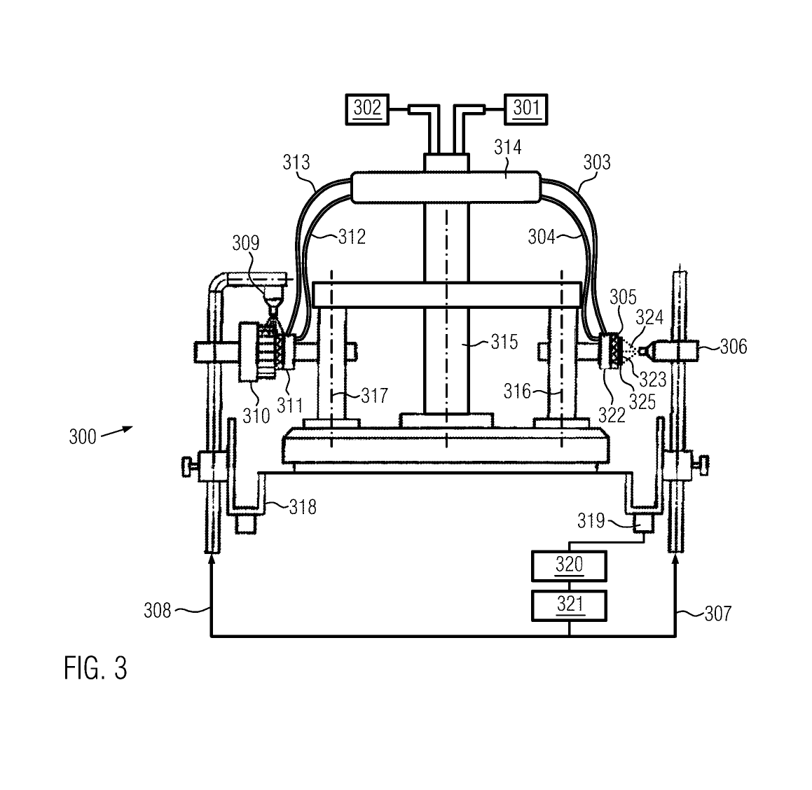

FIG. 3 shows exemplarily a palletizing unit 300 configured e.g. as a carousel and capable of establishing via a distributor 314, e.g. a rotary distributor and/or a ring-line distributor, a connection 303, 313 between a vacuum supply unit 301 and a pallet 322, 311 and/or a connection 303, 304 between a pressurized air supply unit 302 and a pallet 322, 311 for the purpose of vacuum supply and/or pressurized air supply.

Hence, it is selectively possible to generate a negative pressure at the label contacting side 305 of a pallet 322 and/or to apply pressure to the label contacting side 305 of the pallet 322.

For example, the distributor 314 may be arranged such that, when the palletizing unit is in operation, it is positioned above the working plane of the pallets as well as centered with respect to the axis of rotation 315 of the palletizing unit.

However, the vacuum supply unit 301 and/or the pressurized air supply unit 302 themselves may preferably e.g. also be arranged such that, when the palletizing unit is in operation, they may be positioned below the working plane of the pallets.

The distributor 314 may be arranged such that, when the palletizing unit is in operation, it will be positioned below the working plane of the pallets.

The pallets 322, 311 may e.g. be supported such that they are rotatable, with the axes of rotation 316 and 317, and, as described above, they may be adjustable in many ways, in particular shiftable and/or rotatable and/or tiltable and/or vertically adjustable.

In addition, a vertically adjustable activation unit is shown, said activation unit being used for activating the activatable fixing side 323 of a label 325 taken up by a pallet 322, said activation being effected by applying an activating agent 324 to the activatable fixing side 323 of the label 325, e.g. by moistening.

The application of the activating agent 324 to the activatable fixing side 323 of the label 325 can be executed in different ways.

It may e.g. be executed by means of a spray head, which may e.g. be configured e.g. as an inkjet print head. As described above, the activating agent 324 may also be applied to the activatable fixing side 323 of the label 325 by means of rollers or cylinders (not shown), preferably by means of a soft roller.

The exemplary palletizing unit 300 additionally comprises an optional cleaning unit 309, which, making use of e.g. a spray head, may apply a cleaning agent to a pallet 311 at a cleaning position, and clean the pallet to be cleaned 311 by means of a cleaning brush.

The palletizing unit 300 may additionally comprise an at least partially circumferentially extending protection unit/a circumferentially extending protection basin or catch basin 318 for collecting excessive activating agent and/or cleaning agent.

Via an outlet/drain 319 the collected excessive activating agent and/or cleaning agent can then be discharged into a reservoir 320 and can be recycled, e.g. by filtering, and resupplied 307, 308 to an activation unit 306 and/or a cleaning unit 309.

The amount of activating agent and/or cleaning agent consumed can thus be reduced in an advantageous manner.

In addition, the palletizing unit 300 may also comprise a reservoir 321 of new/fresh activating agent and/or cleaning agent.

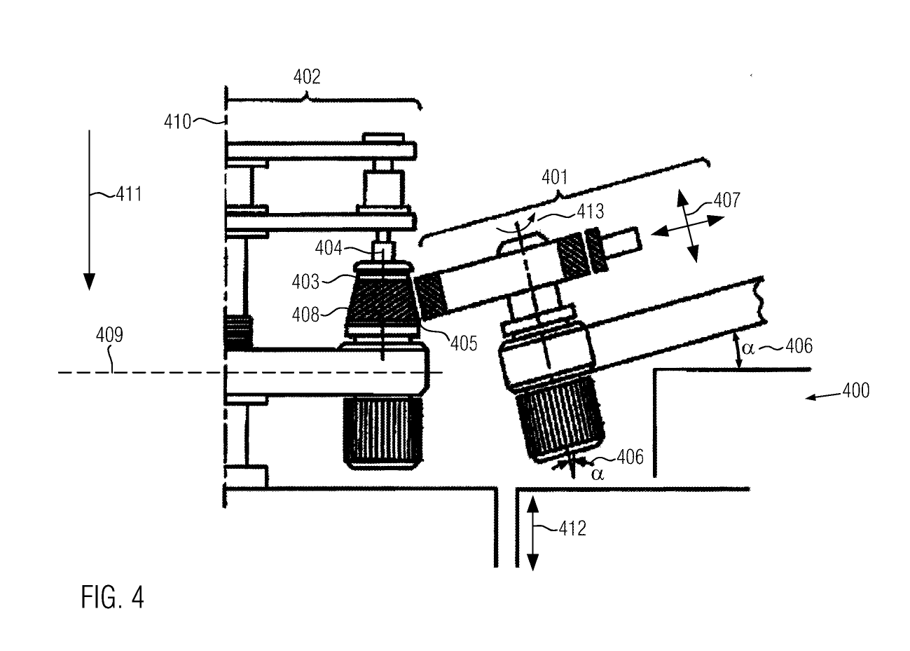

FIG. 4 shows exemplarily a detail 400 of a palletizing unit and of a conveying unit 402 of objects to be labeled, said figure showing a possible geometry between a pallet 401 and an object to be labeled 403 on a conveying unit 402.

Said object may e.g. be conically shaped and e.g. be rotatably 404 supported on the conveying unit 402.

As has already been mentioned more than once, a pallet may by characterized by manifold possibilities of adjustment, so that, for guaranteeing optimum labeling, an optimum orientation of the pallet 401 and of the label contacting side 405 of the pallet 401 can be accomplished for almost any contour/shape of an object to be labeled.

In particular, the pallet 401 may arranged on the palletizing unit such that it is shiftable 407, e.g. shiftable with respect to an object conveying plane or a container conveying plane 409, and/or rotatively 413 displaceable, e.g. rotatively displaceable with respect to an object conveying plane or a container conveying plane 409, and/or tiltable, e.g. tiltable with respect to an object conveying plane or a container conveying plane 409.

Exemplarily, a tilt angle a is shown, by which the pallet 401 can be tilted with respect to a container conveying plane/object conveying plane 409 or displaced with respect to the direction of gravity 411 on the palletizing unit.

This advantageously allows a precise orientation of the label contacting side 405 of the pallet 401 with respect to the labeling area of an object to be labeled 403.

In addition, it should be annotated that the conveying unit 402 may e.g. be configured e.g. as a carousel having an axis of rotation 410, and that the palletizing unit 400 itself may be vertically adjustable.

According to an advantageous embodiment, the palletizing unit may also be configured as a modular unit (not shown). The palletizing unit may here be adapted to be docked onto a machine periphery/labeler periphery/conveying unit periphery, in particular e.g. onto a carousel of a conveying unit for objects to be labeled, onto a vertically adjustable, ground-based unit accommodation means, e.g. such that it is exchangeable and/or movable by means of rollers.

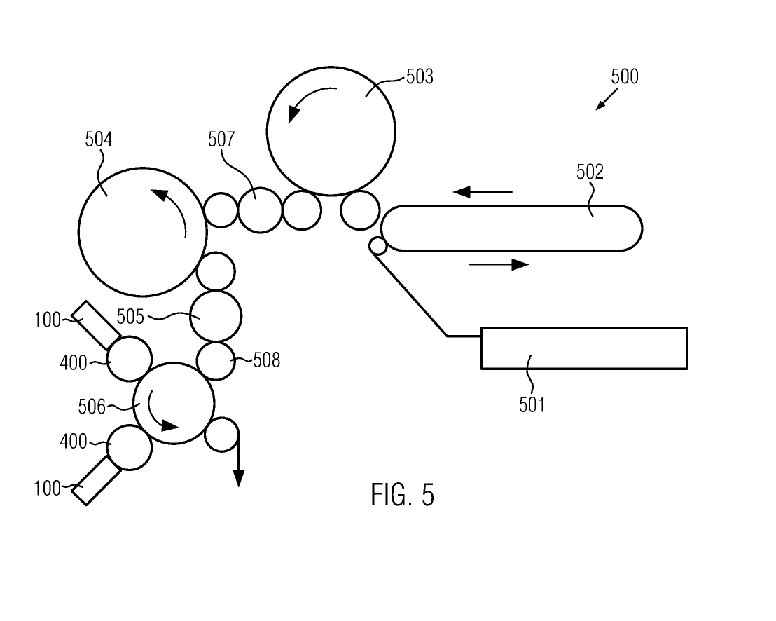

FIG. 5 exemplarily shows a plant block or plant 500 for treating containers, which, due to the use of at least one labeler 100 according to the present disclosure (exemplarily, two labelers 100 are shown) with a palletizing unit 400/palletizing units 400, can be characterized e.g. by a higher efficiency, an optimized flow of material, a simple operating concept and lower space as well as energy requirements, in comparison with conventional plants.

The plant 500 may here comprise a filling device 504 for filling the containers, a closing device 505 for closing the filled containers as well as a labeler 100 according to the present disclosure.

Said labeler(s) 100 may be arranged upstream or downstream of said filling device 504 and/or upstream or downstream of said closing device 505 (as shown).

In addition, said plant 500 may comprise a stretch blow molding device 503 disposed upstream of the filling device and used for producing containers from preforms. Said plant 500 may additionally also comprise a conveyor 501 for preforms as well as a heating unit 502 for preforms.

Furthermore, the plant 500 may comprise a plurality of conveying units 506, 507, 508, which may be configured e.g. as a carousel or as a transport star wheel with neck handling or as a transport star wheel with base handling.

The compact structural design of the plant 500, in particular the omission of structural components, such as a gripper cylinder, in the labeler 100, allows, inter alia, also a minimization of the number of conveying unit changes and/or of the number of gripper changes for a complete container treatment process.

1. A labeler for labeling containers in the food industry, comprising:
at least one label magazine for providing labels having a fixing side that is activatable by moistening, and at least one palletizing unit including at least one pallet for taking up and transferring individual labels, and at least one activating unit for activating, by moistening, the activatable fixing side of a label that has been taken up by a pallet,
wherein the labeler is configured for directly transferring labels from the pallet of the palletizing unit to an object to be labeled.

2. The labeler according to claim 1, wherein the activating unit includes at least one spray head for applying a moistening agent so as to activate the activatable fixing side of the label.

3. The labeler according to claim 2, wherein the spray head provided is an inkjet print head.

4. The labeler according to claim 1, wherein the activation unit includes at least one roller or cylinder for applying a moistening agent so as to activate the activatable fixing side of the label.

5. The labeler according to claim 1, wherein the at least one pallet of the palletizing unit is in connection with a vacuum supply unit and/or in connection with a pressurized air supply unit, and that the at least one pallet of the palletizing unit is configured such that, by means of at least one opening, a negative pressure can be generated at and/or pressurized air can be applied to a label contacting side of the pallet.

6. The labeler according to claim 5, wherein the at least one pallet comprises a plurality of openings at the label contacting side of the pallet and is configured such that said openings can be supplied individually and/or in groups and/or serially and/or simultaneously with pressurized air for pressurized air application, and/or a negative pressure can be generated at said openings individually and/or in groups and/or serially and/or simultaneously.

7. The labeler according to claim 5, wherein control of the application of pressurized air and/or the generation of a negative pressure is effected through or supported by uncovering or covering openings of a rotary disk.

8. The labeler according to claim 5, wherein the the label contacting side of the pallet is provided at least partially with an elastic material.

9. The labeler according to claim 5, wherein the label contacting side of the pallet is provided with at least one suction cup.

10. The labeler according to claim 1, wherein the pallet is arranged on the palletizing unit such that it is shiftable, and/or rotatively displaceable, and/or tiltable.

11. The labeler according to claim 10, wherein the palletizing unit is configured as a carousel having an axis of rotation, and the pallet is arranged on the palletizing unit such that it is rotatively displaceable, and the pallet is arranged such that it is eccentric relative to the axis of rotation of the palletizing unit.

12. The labeler according to claim 1, wherein the palletizing unit includes a catch basin (318) for collecting excessive activating agent or excessive moistening agent.

13. A method for labeling objects, comprising the steps of:
providing labels having a fixing side that is activatable by moistening,
taking up at least one provided label by means of a pallet of a palletizing unit,
activating, through moistening by means of an activating unit, the moisture-activatable fixing side of the label taken up, and
directly transferring and applying the label, with the activated fixing side first, to a surface of the object to be labeled by means of the pallet of the palletizing unit.

14. A plant for treating containers, comprising a filling device for filling the containers, a closing device for closing the filled containers, and labeler according to claim 1 arranged upstream or downstream of said filling device and/or upstream or downstream of said closing device.

15. The plant according to claim 14, comprising additionally a stretch blow molding device disposed upstream of the filling device and used for producing containers from preforms.

16. The labeler according to claim 4, wherein the at least one roller or cylinder is a soft roller.

17. The labeler according to claim 8, wherein the elastic material comprises an elastic sintered plastic material.

18. The labeler according to claim 10, wherein the pallet is arranged on the palletizing unit such that it is shiftable with respect to a container conveying plane.

19. The labeler according to claim 10, wherein the pallet is arranged on the palletizing unit such that it is rotatively displaceable with respect to a container conveying plane.

20. The labeler according to claim 10, wherein the pallet is arranged on the palletizing unit such that it is tiltable with respect to a container conveying plane.
